(19) United States
(12) Patent Application Publication
(10) Pub. No.: US 2013/0263898 A1
(43) Pub. Date: Oct. 10, 2013

(54) ROTATING DRUM TYPE WORK WASHING APPARATUS

(71) Applicants: Hideo Takei, Okaya-shi (JP); Kazutaka Fujimori, Okaya-shi (JP); Masahiko Hiraide, Okaya-shi (JP)

(72) Inventors: Hideo Takei, Okaya-shi (JP); Kazutaka Fujimori, Okaya-shi (JP); Masahiko Hiraide, Okaya-shi (JP)

(21) Appl. No.: 13/881,078

(22) PCT Filed: Sep. 14, 2011
(86) PCT No.: PCT/JP2011/005187

§ 371 Date: Jun. 14, 2013

(30) Foreign Application Priority Data
Nov. 5, 2010 (JP) 2010-248365

(51) Int. Cl. B08B 3/04

(52) U.S. Cl. CPC B08B 3/04
USPC 134/157

(57) ABSTRACT

In a rotating drum (4) of a rotating drum type workpiece washing apparatus (1), a first cylindrical body section (21), in which a liquid impassable part (21a) that follows the circumferential orientation and does not allow a washing solution to pass and a liquid passing part (21b) that allows the washing solution to pass are formed, is provided. With the rotation of a rotating drum (4), workpiece (w) is transported in the direction of the line of the central axis along the inner circumferential surface part on the lower side inside the rotating drum by spiral workpiece transport fins (8) formed along the inner circumferential surface inside the rotating drum. During transport with the rotation of the rotating drum (4), the washing configuration for the workpiece is switched from immersion washing to flowing water washing and shower washing in that order. The workpiece can be washed indifferent configurations; therefore, the washing effect on the workpiece can be increased by the rotating drum with the spiral workpiece transport fins.

### TECHNICAL FIELD

The present invention relates to a rotating drum type workpiece washing apparatus, wherein workpieces such as metal machined articles, plastic molded articles, ceramics and other inorganic machined articles, and rubber articles are inserted into a rotating drum having a helical workpiece feeding fin formed along the internal peripheral surface, and a washing liquid is sprayed to wash the workpieces while the workpieces are conveyed by the workpiece feeding fin through the rotating drum which is rotating.

### BACKGROUND ART

Patent Documents 1 to 4 each disclose a washing apparatus for washing workpieces using a rotating drum. Patent Document 3 proposes a washing apparatus capable of reliably washing without scratching the workpieces. Patent Document 4 proposes a washing apparatus for performing washing efficiently by causing a washing liquid to overflow in the opposite direction of a workpiece feeding direction, by changing the height of a workpiece feeding fin.

### PRIOR ART DOCUMENTS

### Patent Documents

### [Patent Document 1] JP 2004-275819 A

### [Patent Document 2] JP 2001-129499 A

### [Patent Document 3] JP 2008-6364 A

### [Patent Document 4] JP 4557888 B

### DISCLOSURE OF THE INVENTION

### Problems Solved by the Invention

In a rotating drum type workpiece washing apparatus, in the bottom portion of the internal peripheral surface of a transverse-mounted rotating drum, workpieces positioned between adjacent workpiece feeding fins are fed out in the axial direction of the rotating drum by the workpiece feeding fins as the rotating drum rotates. When the rotating drum is a metal cylinder, washing liquid accumulates between adjacent workpiece feeding fins, and the workpieces are fed while immersed in the washing liquid. Therefore, the workpieces are immersion washed while being conveyed.

When the rotating drum is a cylinder composed of a porous plate such as punched metal, washing liquid does not accumulate between the workpiece feeding fins, and the workpieces are therefore fed by the workpiece feeding fins while being sprayed with the washing liquid. Therefore, the workpieces are shower washed while being conveyed.

In the washing apparatus disclosed in Patent Document 4, washing liquid that has accumulated between the workpiece feeding fins overflows to the workpiece entrance side. Therefore, the washing effects are high because the workpieces are immersion washed and washed by running liquid while being conveyed.

In a rotating drum type workpiece washing apparatus, it is preferable for immersion washing, shower washing, and washing by running liquid to be performed simultaneously or consecutively on workpieces conveyed by a helical workpiece feeding fin as the rotating drum rotates, because the workpiece washing efficiency can be increased.

In view of these matters, an object of the present invention is to provide a rotating drum type workpiece washing apparatus that has high washing effects, wherein immersion washing, shower washing, and washing by running liquid can be repeated as the rotating drum rotates, without greatly altering the structure of the rotating drum.

### Means to Solve the Problems

To solve the problems described above, a rotating drum type workpiece washing apparatus according to the present invention is characterized in that:

a transverse-mounted rotating drum is rotated about a center axis thereof, a workpiece inserted into the rotating drum is fed out in the direction of the center axis along an internal peripheral surface portion positioned at the bottom of the rotating drum, the workpiece being fed by a workpiece feeding fin formed in a helical shape along the internal peripheral surface of the rotating drum, and a washing liquid is sprayed onto the workpiece fed out by the workpiece feeding fin to wash the workpiece;

at least part of a cylindrical body section of the rotating drum is a first cylindrical body section for performing immersion washing, washing by running liquid, and shower washing on the workpiece while the rotating drum rotates once; and

in the first cylindrical body section, a portion of the circumferential surface in a predetermined range in the circumferential direction is a liquid impassable portion formed from a plate through which the washing liquid does not pass, and the remaining portion of the circumferential surface in the circumferential direction is a liquid passable portion formed from a porous plate through which the washing liquid does pass.

In the rotating drum type workpiece washing apparatus of the present invention, when the workpiece is inserted into the rotating drum and the rotating drum is rotated, the workpiece is conveyed in a direction along the center axis of the rotating drum by the helical workpiece feeding fin through a bottom internal peripheral surface portion positioned at the bottom of the cylindrical body section of the rotating drum. The washing liquid is sprayed onto the workpiece inside the rotating drum. Specifically, the washing liquid is sprayed onto the bottom internal peripheral surface portion where the workpiece is positioned in the internal peripheral surface of the rotating drum.

In the first cylindrical body section of the rotating drum, the bottom internal peripheral surface portion alternately switches between the liquid impassable portion and the liquid passable portion as the rotating drum rotates. When the liquid impassable portion is positioned at the bottom, the washing liquid accumulates between adjacent feeding fin portions in the workpiece feeding fin. Therefore, the workpiece is conveyed while immersed in the washing liquid, and the manner of washing the workpiece is therefore primarily immersion washing.

When the liquid passable portion is positioned at the bottom, the washing liquid flows out downward from the rotating drum through the liquid passable portion, and the washing liquid therefore does not accumulate between adjacent feeding fin portions of the workpiece feeding fin in the bottom internal peripheral surface portion of the rotating drum. As a result, washing liquid is sprayed directly onto the workpiece conveyed by the workpiece feeding fin, and the manner of washing the workpiece is primarily shower washing.

When the bottom internal peripheral surface portion of the first cylindrical body section gradually switches from the liquid impassable portion to the liquid passable portion, the washing liquid accumulated between adjacent feeding fin portions of the workpiece feeding fin gradually flows out from the liquid passable portion. Therefore, as the rotating drum rotates, the manner of washing the workpiece transitions from immersion washing to washing by running liquid and then to shower washing.

Conversely, when the bottom internal peripheral surface portion of the first cylindrical body section gradually switches from the liquid passable portion to the liquid impassable portion, the washing liquid begins to gradually accumulate between the adjacent feeding fin portions of the workpiece feeding fin. Therefore, as the rotating drum rotates, the manner of washing the workpiece transitions from shower washing to washing by running liquid and then to immersion washing.

Thus, in the rotating drum type workpiece washing apparatus of the present invention, while the first cylindrical body section of the rotating drum rotates once, the manner of washing the conveyed workpiece switches sequentially to immersion washing, washing by running liquid, and shower washing. Specifically, in a first rotational angle range which includes a rotational angle position wherein the liquid impassable portion is positioned directly below the center axis of the rotating drum, immersion washing is performed with the workpiece immersed in the washing liquid accumulated between the adjacent feeding fin portions of the workpiece feeding fin. In a second rotational angle range which includes a rotational angle position wherein the liquid passable portion is positioned directly below the center axis of the rotating drum, shower washing is performed in which the washing liquid is sprayed directly onto the workpiece. In rotational angle ranges other than the first rotational angle range and the second rotational angle range, washing of the workpiece by running liquid is performed by the washing liquid flowing from the liquid impassable portion to the liquid passable portion. Consequently, the workpiece can be washed by different manners of washing in each rotation of the rotating drum, and the workpiece washing effect can therefore be increased. Because the rotating drum need only have a liquid passable portion and a liquid impassable portion formed along the circumferential direction, the workpiece can be washed by three different manners of washing without making large alterations to the rotating drum.

The rotating drum is preferably rotatably driven in a shaking rotation mode. In the shaking rotation mode, the rotating drum is repeatedly rotated in a first direction, and during each rotation, the rotating drum is repeatedly turned in a first direction and an opposite second direction in a predetermined angle range within the one rotation. For example, within the rotational angle range in which immersion washing is performed in the rotating drum, the rotating drum is repeatedly turned in the first direction and the second direction.

Thus, the workpiece carried on the bottom internal peripheral surface portion of the rotating drum is repeatedly shaken in the first direction and the second direction along the bottom internal peripheral surface portion. Because the orientation of the workpiece is changed by the shaking and the washing liquid reaches different parts of the workpiece, washing of the workpiece can be performed efficiently. For example, in the case of a cup-shaped workpiece, the washing liquid cannot be sprayed into the concave part of the workpiece while the opening remains facing the internal peripheral surface of the rotating drum, but by shaking and inverting the workpiece, the washing liquid can be directly sprayed into the concave part of the workpiece to wash the concave part.

To change the orientation of the workpiece, workpiece raising members can be used for temporarily raising up the workpiece fed by the workpiece feeding fin from the internal peripheral surface of the rotating drum. Specifically, the workpiece raising members may be disposed as spanning between adjacent feeding fin portions in the workpiece feeding fin, which are adjacent in the direction of the center axis. The workpiece, which is fed by the workpiece feeding fin over the bottom internal peripheral surface portion of the rotating drum, is raised upon contact with the workpiece raising members disposed midway through, and the orientation of the workpiece changes. Therefore, the washing liquid can reach all different parts of the workpiece, and the washing effect can be increased.

Next, in the rotating drum type washing apparatus, a plurality of rotating drums are connected in tandem, and the workpiece is subjected to treatments such as washing and rinsing. It is convenient if a single rotating drum can be divided in two front-to-back in the direction of the center axis, and the workpiece can be treated using different liquids (e.g. a washing liquid and a rinsing liquid).

To achieve this, a feeding fin portion wound one loop or longer along the internal peripheral surface of the first cylindrical body section in the workpiece feeding fin may be a partitioning feeding fin portion that is taller than other feeding fin portions. The interior of the rotating drum is partitioned front-to-back in the direction of the center axis by the tall partitioning feeding fin portion. The workpiece can be washed using the washing liquid in the front portion of the rotating drum, and the workpiece can be rinsed using a rinsing liquid in the rear portion. The tall partitioning feeding fin can prevent the washing liquid from flowing into the rear workpiece rinsing portion. Because the liquid passable portion is formed in the first cylindrical body section, the washing liquid flows out of the rotating drum through the liquid passable portion. Consequently, the washing liquid can be reliably prevented from flowing into the workpiece rinsing portion at the rear.

The cylindrical body section of the rotating drum can entirely be formed from the first cylindrical body section, but another possibility is a configuration provided with the first cylindrical body section, and a third cylindrical body section composed of a porous plate through which the washing liquid passes and/or a second cylindrical body section composed of a plate through which the washing liquid does not pass. The manner of washing a workpiece conveyed through the second cylindrical body section is immersion washing, and the manner of washing a workpiece conveyed through the third cylindrical body section is shower washing.

In this case, a possible configuration is that the third cylindrical body section, the second cylindrical body section, and the first cylindrical body section are formed in the order listed along the workpiece feeding direction of the workpiece feeding fin that accompanies the rotation of the rotating drum. A workpiece to be washed inserted into the rotating drum is first shower washed while passing through the third cylindrical body section, and comparatively large impurities adhering to the workpiece are washed off by the washing liquid. The washed off impurities flow out of the rotating drum together with the washing liquid. Next, the workpiece is immersion washed while passing through the second cylindrical body section, and the washing liquid comes in contact with the entire workpiece surface and washes off the impurities. Then, while passing through the first cylindrical body section, the workpiece is immersion washed, washed by running liquid, and shower washing with each rotation of the rotating drum. Because the workpiece is exposed to new washing liquid with each rotation and washed by a different manner of washing, a finish washing can be performed for reliably washing off tiny impurities and the like.

A rotating drum type workpiece washing apparatus of the present invention is characterized in that:

a transverse-mounted rotating drum is rotated about a center axis thereof, a workpiece inserted into the rotating drum is fed out in the direction of the center axis along an internal peripheral surface portion positioned at the bottom of the rotating drum, the workpiece being fed by a workpiece feeding fin formed in a helical shape along the internal peripheral surface of the rotating drum, and a washing liquid is sprayed onto the workpiece fed out by the workpiece feeding fin to wash the workpiece;

at least part of a cylindrical body section of the rotating drum is a first cylindrical body section for performing immersion washing, washing by running liquid, and shower washing on the workpiece while the rotating drum rotates once;

in the first cylindrical body section, a portion of the circumferential surface in a predetermined range in the circumferential direction is a liquid impassable portion formed from a plate through which the washing liquid does not pass, and the remaining portion of the circumferential surface in the circumferential direction is a liquid passable portion formed from a porous plate through which the washing liquid does pass;

the apparatus comprises:

a drum incline mechanism capable of varying the incline angle of the rotating drum; and

a controller for controlling the rotation of the rotating drum, the incline angle of the rotating drum by the drum incline mechanism, and the washing liquid spraying action;

one end of the rotating drum is open as an insertion/ejection port where workpieces are inserted and ejected, the other end is a closed end; and

alternately performed under the control of the controller are a workpiece-in washing action in which the rotating drum is rotated in a first direction in an inclined orientation wherein the insertion/ejection port of the rotating drum is positioned higher than the closed end and washing liquid is sprayed onto the workpiece while the workpiece is fed in toward the closed end, and a workpiece-out washing action in which the rotating drum is rotated in a second direction opposite of the first direction in an inclined orientation wherein the insertion/ejection port of the rotating drum is positioned lower than the closed end and washing liquid is sprayed onto the workpiece while the workpiece is fed out from the closed end toward the insertion/ejection port.

In the rotating drum type workpiece washing apparatus of the present invention, the incline angle of the rotating drum can be switched by the drum incline mechanism so as to put the insertion/ejection port in a position higher and a position lower than the closed end on the opposite side. Lightweight rubber or plastic ring-shaped workpieces, i.e. O rings, seal rings, and the like readily adhere to the internal peripheral surface of the rotating drum and roll readily along the internal peripheral surface, and there are therefore cases in which workpieces cannot be conveyed efficiently by the workpiece feeding fin. In the present invention, workpieces can be conveyed efficiently because the incline angle of the rotating drum is switched to lower the conveying direction.

The rotating drum type workpiece washing apparatus of the present invention is characterized in that:

the cylindrical body section of the rotating drum has a second cylindrical body section and a third cylindrical body section;

the second cylindrical body section is a portion for performing immersion washing formed from a plate through which liquid does not pass;

the third cylindrical body section is a portion for performing shower washing formed from a porous plate through which liquid does pass;

the third cylindrical body section, the first cylindrical body section, and the second cylindrical body section are formed in the listed order beginning at the side having the insertion/ejection port;

the front end of the third cylindrical body section is the insertion/ejection port; and

the rear end of the second cylindrical body section is the closed end.

During a feed-in step of being fed in toward the closed end of the rotating drum, workpieces inserted into the insertion/ejection port of the rotating drum of this configuration are shower washed while passing through the third cylindrical body section; immersion washed, washed by running liquid, and shower washed with each rotation while passing through the first cylindrical body section; and immersion washed while passing through the second cylindrical body section. After the workpieces have been immersion washed when the workpieces are washed during a feed-out step in which the workpieces are returned from the closed end of the rotating drum to the insertion/ejection port, the workpieces are immersion washed, washed by running liquid, and shower washed with each rotation, and finally shower washed. Thus, workpieces can be washed efficiently by performing washing in different manners of washing in the workpiece feeding direction as well.

The cylindrical body section of the rotating drum can be configured from a wire netting cylinder, and a metal plate attached so as to hide part of the external peripheral surface of this wire netting cylinder. Specifically, in the first cylindrical body section, a circumferential portion of the wire netting cylinder is covered by an arcuate metal plate, the third cylindrical body section is defined by the wire netting cylinder, and the second cylindrical body section is preferably designed so that the entire external peripheral surface of the wire netting cylinder is covered by a cylindrical metal plate. Because the entire internal peripheral surface of the rotating drum is defined by the wire netting cylinder, workpieces such as lightweight rubber rings can be prevented from remaining affixed to the internal peripheral surface, and the workpieces can be reliably conveyed. Numerous holes may of course be provided to the necessary portion of a cylinder composed of a metal plate to form a liquid passable portion.

Furthermore, a portion equivalent to at least one loop from the open edge of the insertion/ejection port in the workpiece feeding fin constitutes a workpiece feeding fin made of punched metal which is taller than the other portions, and protruding parts are preferably provided at predetermined intervals along the punched metal workpiece feeding fin in either the surface of the punched metal workpiece feeding fin on the side facing the insertion/ejection port, or in the internal peripheral surface of the cylindrical body section, in the portion between the punched metal workpiece feeding fin and the insertion/ejection port.

When washed workpieces are ejected from the insertion/ejection port, there are cases in which the workpieces are not ejected by rolling along the internal peripheral surface portion in the open edge of the insertion/ejection port of the rotating drum. In the present invention, the workpieces rolling along the internal peripheral surface portion collide with the protruding parts, and the workpieces are reliably ejected out of the rotating drum from the insertion/ejection port.

### Effect of the Invention

In the rotating drum type workpiece washing apparatus of the present invention, the rotating drum is provided with a first cylindrical body section, in which a liquid passable portion through which washing liquid passes and a liquid impassable portion through which washing liquid does not pass are formed along the circumferential direction. Therefore, the manner in which workpieces are washed switches to immersion washing, washing by running liquid, and shower washing with each rotation of the rotating drum. Because the workpieces are washed repeatedly by different manners of washing, the washing effects of the rotating drum type workpiece washing apparatus can be increased. Therefore, because there is no need to greatly alter the rotating drum, a rotating drum type workpiece washing apparatus that is highly effective at washing can be cheaply constructed.

### BRIEF DESCRIPTION OF THE DRAWINGS

FIG. 1 contains a side view showing the main portion of a rotating drum type workpiece washing apparatus according to Embodiment 1 to which the present invention is applied, a transverse cross-sectional view showing the portion sectioned by line b-b, a transverse cross-sectional view showing the portion sectioned by line c-c, and a longitudinal cross-sectional view thereof;

FIG. 2 contains explanatory drawings showing the washing action of the rotating drum type workpiece washing apparatus of FIG. 1;

FIG. 3 contains explanatory drawings showing an example of a shaking rotation mode of the rotating drum in the rotating drum type workpiece washing apparatus of FIG. 1;

FIG. 4 is an external perspective view showing the rotating drum type workpiece washing apparatus according to Embodiment 2 to which the present invention is applied;

FIG. 5 contains an external perspective view showing a state in which the front cover of the rotating drum type workpiece washing apparatus of FIG. 4 is open, and an external perspective view showing a state in which the top cover has been removed;

FIG. 6 contains a perspective view showing an extracted view of the rotating drum and the drive mechanism thereof in the rotating drum type workpiece washing apparatus of FIG. 4, a side view of the same, a front view showing a workpiece insertion/ejection port of the rotating drum, and a rear view showing the closed end of the rotating drum; and

FIG. 7 contains an explanatory drawing showing a workpiece-in state of the rotating drum, and an explanatory drawing showing a workpiece-out state of the rotating drum.

### MODE FOR CARRYING OUT THE INVENTION

Embodiments of a rotating drum type workpiece washing apparatus to which the present invention is applied are described below with reference to the drawings.

### Embodiment 1

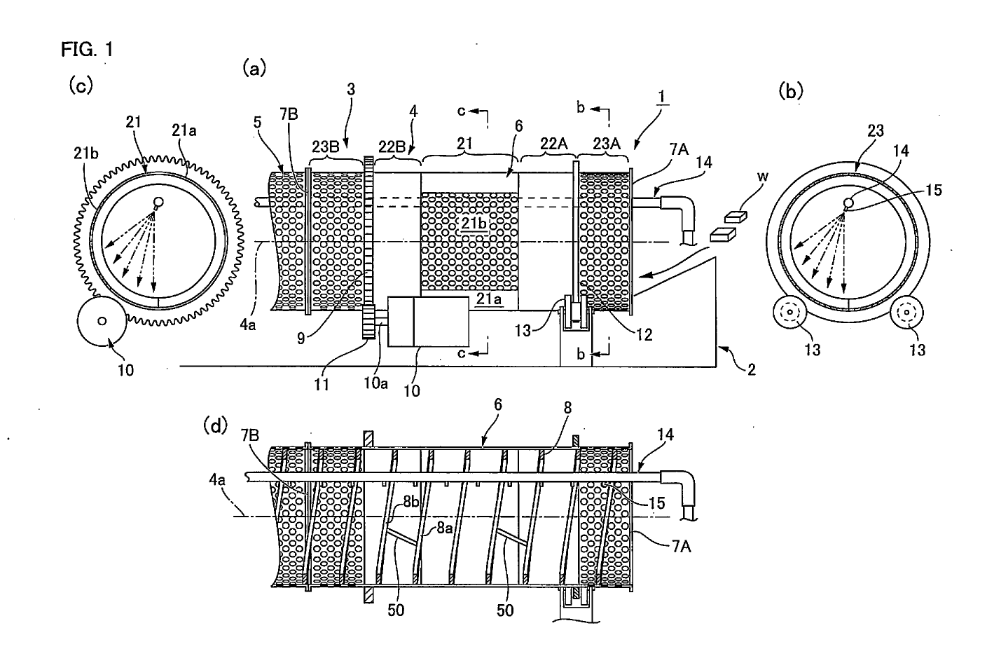

FIG. 1 contains drawings showing a rotating drum type workpiece washing apparatus according to Embodiment 1, wherein (a) is a side view thereof, (b) is a transverse cross-sectional view showing the portion sectioned by line b-b, (c) is a transverse cross-sectional view showing the portion sectioned by line c-c, and (d) is a longitudinal cross-sectional view thereof. A rotating drum type workpiece washing apparatus 1 is a multi-tank in-line washing apparatus for washing a workpiece w such as a metal machined component manufactured by pressing or the like, for example, as an object to be washed; the apparatus comprising a rotating drum unit 3 mounted on an apparatus stand 2. The rotating drum unit 3 is a transverse-mounted rotating drum unit in which a rotating drum 5 for rinse washing and a rotating drum for drying (not shown) are connected in tandem to a rotating drum 4 for washing, and the rotating drum unit 3 is arranged so that the center axis thereof is horizontal.

The rotating drum 4 for washing includes a cylindrical body section 6, the distal end opening of the cylindrical body section 6 constitutes a workpiece insertion hole 7A, and the rear end opening constitutes a workpiece ejection hole 7B. The workpiece ejection hole 7B of the cylindrical body section 6 is connected to the rotating drum 5 for rinse washing. A workpiece feeding fin 8 is attached to the circular internal peripheral surface of the cylindrical body section 6, and the workpiece feeding fin 8 is arranged at a constant pitch with a helical shape along the center axis 4a of the cylindrical body section 6. The workpiece feeding fin 8 is a fin of a predetermined height, erected at a right angle from the circular internal peripheral surface of the cylindrical body section 6.

Workpiece raising members 50, which are for temporarily raising the workpiece w fed by the workpiece feeding fin 8 from the circular internal peripheral surface of the rotating drum 4, are disposed as shown in FIG. 1(d). The workpiece raising members 50 span between adjacent feeding fin portions 8a, 8b, which are adjacent along the center axis 4a of the rotating drum in the workpiece feeding fin 8. Workpiece raising members consisting of elevated portions of the circular internal peripheral surface of the rotating drum 4 may be formed so as to span between adjacent feeding fin portions 8a, 8b. The workpiece raising members 50 of this example are long, thin rod-shaped members having circular cross sections, and are disposed at predetermined intervals along the workpiece feeding fin 8, for example. Members having shapes and structures other than rod-shaped members can also be used.

In the area of the cylindrical body section 6 where the workpiece ejection hole 7B is located, an annular driven gear 9 is fixed to the external peripheral surface. This driven gear 9 is meshed with a drive gear 11 fixed to the distal end of a rotating shaft 10a of a rotating actuator 10 (a drum-rotating mechanism) composed of a motor and a speed reducer. An annular rib 12 is fixed to the external peripheral surface of the cylindrical body section 6 on the side having the workpiece insertion hole 7A, and this rib 12 is supported by a pair of left and right supporting rollers 13. The rotating drum unit 3 including the rotating drum 4 is rotated about the center axis by the driving of the rotating actuator 10.

A washing liquid supply tube 14 is disposed inside the rotating drum 4 in a state of extending parallel to the center axis 9a, and washing liquid spray nozzles 15 are attached to the washing liquid supply tube 14 at fixed intervals along the length direction thereof. The washing liquid spray nozzles 15 are designed so as to spray the washing liquid out at a downward incline.

The cylindrical body section 6 of the rotating drum 4 comprises a first cylindrical body section 21, and a front second cylindrical body section 22A and rear second cylindrical body section 22B formed coaxially on the front end (the end on the side having the workpiece insertion hole 7A) and rear end (the end on the side having the workpiece ejection hole 7B) thereof, respectively. The cylindrical body section 6 also comprises a front third cylindrical body section 23A formed coaxially at the front end of the front second cylindrical body section 22A, and a rear third cylindrical body section 23B formed coaxially at the rear end of the front second cylindrical body section 22A.

When viewed along the circumferential direction, the first cylindrical body section 21 comprises a liquid impassable portion 21a composed of a metal plate that does not allow passage of the washing liquid, and a liquid passable portion 21b composed of perforated metal (a porous plate) that does allow passage of the washing liquid, as shown in FIG. 1(a). For example, the liquid impassable portion 21a is an arcuate portion of a fixed width encompassing an angle of 270 degrees in the circumferential direction, and the liquid passable portion 21b is an arcuate portion of a fixed width encompassing an angle of 90 degrees in the circumferential direction. The front second cylindrical body section 22A and the rear second cylindrical body section 22B are both liquid impassable cylindrical body sections formed entirely from a metal plate. The front third cylindrical body section 23A and the rear third cylindrical body section 23B are both liquid passable cylindrical body sections formed entirely from perforated metal.

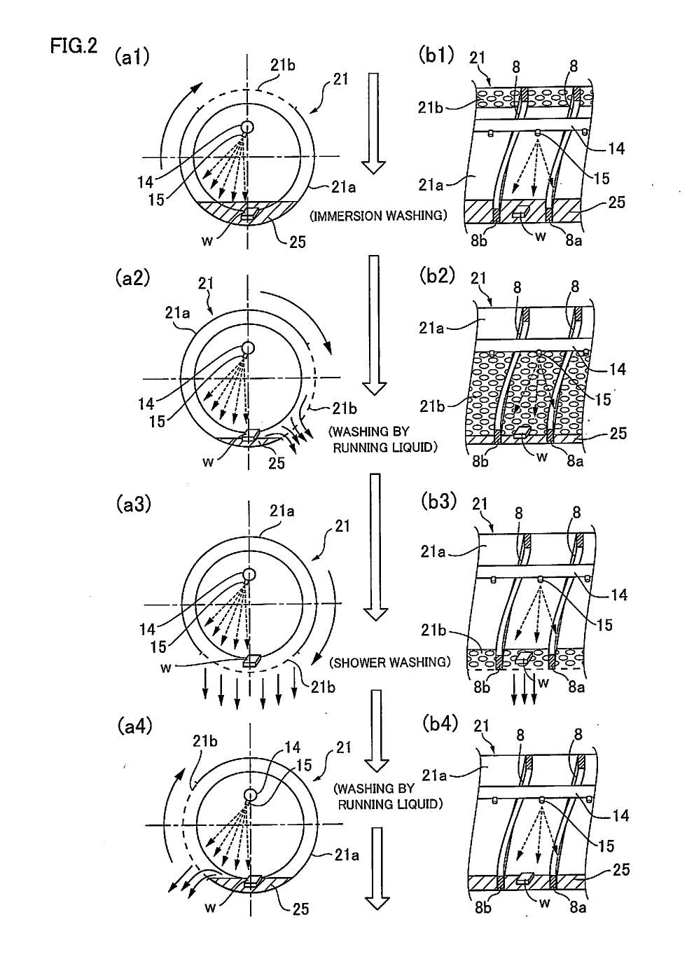

FIG. 2 contains explanatory drawings showing the workpiece washing action of the rotating drum 4 for washing. The rotating actuator 10 is driven to rotate the rotating drum 4, and the washing liquid is sprayed out from the washing liquid spray nozzles 15. In this state, the workpiece w to be washed is inserted through the workpiece insertion hole 7A of the rotating drum 4. The workpiece w inserted into the rotating drum 4 is conveyed along the center axis 4a of the rotating drum 4, over the bottom internal peripheral surface portion positioned at the bottom of the circular internal peripheral surface in the cylindrical body section 6 of the rotating drum 4, by the helical workpiece feeding fin 8. The washing liquid sprayed out from the washing liquid spray nozzles 15 is sprayed onto the bottom internal peripheral surface portion of the cylindrical body section 6, and the liquid flows down to the lowest position of the bottom internal peripheral surface portion.

The workpiece w is held in a portion slightly farther along the rotational direction of the rotating drum 4 than the lowest position in the bottom internal peripheral surface portion of the cylindrical body section 6 of the rotating drum 4. In response, the washing liquid spray direction of the washing liquid spray nozzles 15 is entirely designed to be slightly inclined from being vertical toward the rotational direction of the rotating drum 4.

Because the front third cylindrical body section 23A on the workpiece insertion hole 7A side of the rotating drum 4 is formed from punched metal (perforated metal), the washing liquid does not accumulate in the bottom internal peripheral surface portion but instead flows downward. Therefore, washing liquid is sprayed directly onto the workpiece w conveyed by the workpiece feeding fin 8, adhering impurities and the like are washed off by the washing liquid, and the impurities fall out along with the washing liquid.

The front second cylindrical body section 22A connected to the rear side of the front third cylindrical body section 23A is a cylindrical body section formed from a metal plate, the sprayed washing liquid accumulates between adjacent feeding fin portions of the workpiece feeding fin 8 in the bottom internal peripheral surface portion of the front second cylindrical body section 22A, and the workpiece w is conveyed while being immersed in the accumulated washing liquid. Therefore, the manner in which the workpiece is washed while being conveyed through the front second cylindrical body section 22A is primarily immersion washing.

Next, in the first cylindrical body section 21, which is continuous with the rear side of the front second cylindrical body section 22A, three fourths in the circumferential direction is the liquid impassable portion 21a composed of a metal plate, and the remaining one fourth is the liquid passable portion 21b composed of punched metal. Therefore, the bottom internal peripheral surface portion switches alternately between the liquid impassable portion 21a and the liquid passable portion 21b with the rotation of the rotating drum 4.

While the liquid impassable portion 21a is positioned at the bottom as shown in FIGS. 2(a1) and (b1), the washing liquid 25 sprayed out from the washing liquid spray nozzles 15 accumulates between adjacent portions 8a, 8b of the workpiece feeding fin 8. Therefore, the workpiece w is conveyed while being immersed in the washing liquid 25, and the manner in which the workpiece w is washed is therefore primarily immersion washing.

While the liquid passable portion 21b is positioned at the bottom as shown in FIGS. 2(a3) and (b3), the washing liquid 25 flows out through the liquid passable portion 21b, and the washing liquid does not accumulate in the bottom portion of the rotating drum 4. Because the washing liquid 25 sprayed out from the washing liquid spray nozzles 15 is sprayed on the workpiece w conveyed by the workpiece feeding fin 8, the manner in which the workpiece w is washed is primarily shower washing. When the washing liquid, which is ejected at high pressure from the washing liquid spray nozzles 15, is sprayed onto workpieces being conveyed in an overlapped state along the liquid passable portion 21b, the liquid passes through a small gap formed with the top workpiece to be sprayed at high pressure onto the bottom workpiece as well, after which the liquid passes through the liquid passable portion 21b. Therefore, when the workpiece is carried in an overlapped stated along the liquid passable portion 21b, the washing liquid is reliably sprayed onto the bottom workpiece as well, and both workpieces are reliably shower washed.

When the portion positioned at the bottom of the first cylindrical body section 21 is gradually switched from the liquid impassable portion 21a to the liquid passable portion 21b as shown in FIGS. 2(a2) and (b2), the washing liquid 25 accumulated between adjacent portions 8a, 8b of the workpiece feeding fin 8 gradually flows out through the liquid passable portion 21b. Consequently, as the rotating drum 4 rotates, the manner in which the workpiece w is washed transitions from immersion washing shown in FIGS. 2(a1) and (b1) to washing by running liquid, and thereafter transitions to shower washing shown in FIGS. 2(a3) and (b3).

Conversely, when the portion of the first cylindrical body section 21 positioned at the bottom gradually switches from the liquid passable portion 21b to the liquid impassable portion 21a, washing liquid begins to gradually accumulate between adjacent portions 8a, 8b of the workpiece feeding fin 8, as shown in FIGS. 2(a4) and (b4). Therefore, the manner in which the workpiece w is washed transitions from the shower washing shown in FIGS. 2(a3) and (b3) to washing by running liquid, and thereafter transitions to the immersion washing shown in FIGS. 2(a1) and (b1).

Therefore, as the rotating drum 4 for washing rotates, the drum conveys the workpiece w toward the rear end while sequentially performing the immersion washing of the workpiece shown in FIGS. 2(a1) and (b1), the washing of the workpiece by running liquid shown in FIGS. 2(a2) and (b2), the shower washing of the workpiece shown in FIGS. 2(a3) and (b3), and the washing by running liquid shown in FIGS. 2(a4) and (b4). Specifically, in a first rotational angle range which includes a rotational angle position wherein the liquid impassable portion 21a is positioned directly below the center axis 4a of the rotating drum 4, immersion washing is performed with the workpiece immersed in the washing liquid accumulated between the adjacent portions 8a, 8b of the workpiece feeding fin 8; in a second rotational angle range which includes a rotational angle position wherein the liquid passable portion 21b is positioned directly below the center axis 4a of the rotating drum 4, shower washing is performed in which the washing liquid is sprayed directly onto the workpiece w; and in rotational angle ranges other than the first rotational angle range and the second rotational angle range, washing of the workpiece by running liquid is performed by the washing liquid flowing from the liquid impassable portion to the liquid passable portion. Of course, during a switch to a different manner of washing, both manners of washing are taking place.

Next, the workpiece w is immersion washed while passing through the rear second cylindrical body section 22B, and is again shower washed while passing through the next rear third cylindrical body section 23B. After being washed by the washing liquid in this manner, the workpiece w is fed to the rotating drum 5 for rinse washing of the next stage, and the workpiece w is subjected to rinse washing.

As described above, in the rotating drum 4 for washing of the rotating drum type workpiece washing apparatus 1, with each rotation of the first cylindrical body section 21 of the rotating drum, the workpiece w being conveyed is repeatedly subjected to immersion washing, washing by running liquid, and shower washing in the order listed. Therefore, the efficiency of washing the workpiece by the rotating drum 4 for washing can be increased.

Because the rotating drum 4 need only have the liquid impassable portion 21a and the liquid passable portion 21b formed along the circumferential direction, three different manners of washing the workpiece can be implemented without making any severe alterations to the rotating drum 4, and there are virtually no increases to the manufacturing costs of the rotating drum 4.

Furthermore, while being fed through the rotating drum 4 from the workpiece insertion hole 7A to the workpiece ejection hole 7B, the workpiece w is shower washed in the front third cylindrical body section 23A; immersion washed in the front second cylindrical body section 22A; immersion washed, washed by running liquid, and shower washed as described above in the first cylindrical body section 21; immersion washed in the rear second cylindrical body section 22B; and shower washed in the rear third cylindrical body section 23B. Consequently, the effects of washing the workpiece w by the rotating drum 4 can be increased.

Furthermore, the workpiece raising members 50 are disposed at positions midway through the workpiece feeding fin 8. The workpiece w fed out by the workpiece feeding fin 8 touches the workpiece raising members 50, the workpiece is temporarily raised up from circular internal peripheral surface of the rotating drum 4, and the orientation of the workpiece changes. As a result, the washing liquid is reliably brought in contact with the entire surface of the workpiece w, and impurities can be reliably washed off even if the workpiece has concavities, grooves, or the like.

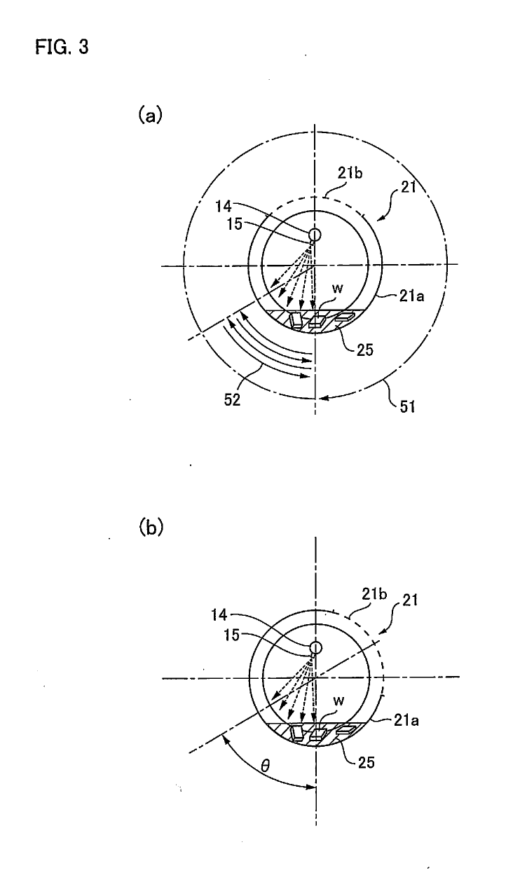

To further increase the effects of washing the workpiece by the rotating drum 4, the rotating drum 4 is preferably shakably rotated as shown in FIG. 3. In this shaking rotation, the rotating drum 4 is repeatedly rotated in a first direction 51, and within a single rotation, the rotating drum 4 is repeatedly turned in the first direction 51 and an opposite second direction 52 in a predetermined angle range θ within one rotation. For example, in the rotational angle range in which immersion washing is performed in the rotating drum 4, the rotating drum 4 is repeatedly rotated in the first direction 51 and the second direction 52 between the rotation position shown in FIG. 3(a) and the rotation position shown in FIG. 3(b).

In this case, the workpiece w carried on the bottom internal peripheral surface portion of the rotating drum 4 repeatedly shakes in the first direction 51 and the second direction 52 along the bottom internal peripheral surface portion. Because the orientation of the workpiece w is varied by the shaking and the washing liquid reaches different parts of the workpiece w, the workpiece can be washed more efficiently. For example, when numerous workpieces have piled up, these workpieces can be shaken apart, and the workpieces can be reliably washed by the washing liquid.

Next, in the present example, a plurality of rotating drums 4, 5, etc. are connected in tandem, and various treatments such as washing and rinsing are performed on the workpiece. A single rotating drum can also be divided in two front-to-back in the direction of the center axis, and the workpiece can be treated using different liquids (e.g. a washing liquid and a rinsing liquid). To achieve this, a feeding fin portion wound one loop or longer along the internal peripheral surface of the first cylindrical body section 21 in the workpiece feeding fin 8 may be a partitioning feeding fin portion that is taller than other feeding fin portions.

The interior of the rotating drum 4 is partitioned front-to-back in the direction of the center axis 4a by the tall partitioning feeding fin portion. The workpiece can be washed using the washing liquid in the front portion of the rotating drum 4, and the workpiece can be rinsed using a rinsing liquid in the rear portion. The tall partitioning feeding fin portion can prevent the washing liquid from flowing into the rear portion. Because the liquid passable portion 21b is formed in the first cylindrical body section 21, the washing liquid flows out of the rotating drum through the liquid passable portion 21b. As a result, the washing liquid can be reliably prevented from flowing into the workpiece rinsing portion at the rear. Consequently, it is possible to form a state in which the rotating drum 4 is reliably partitioned front-to-back.

### Embodiment 2

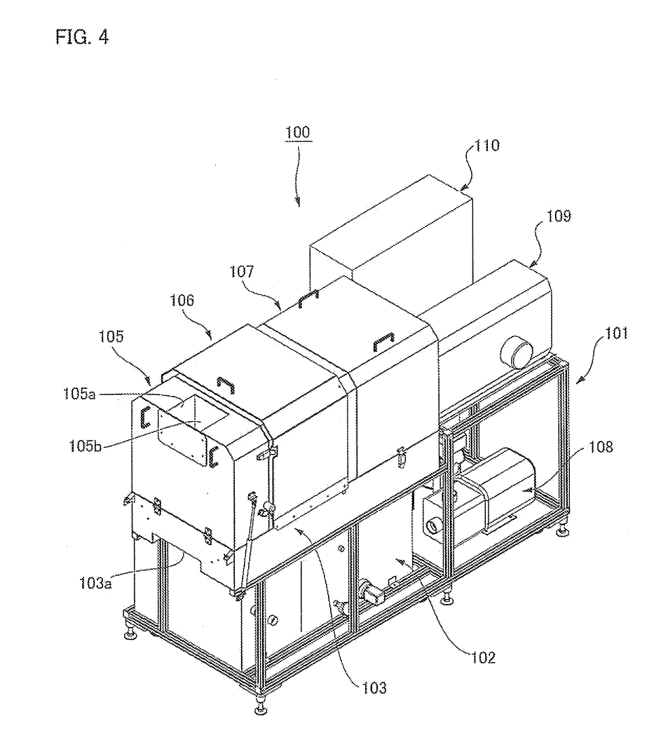

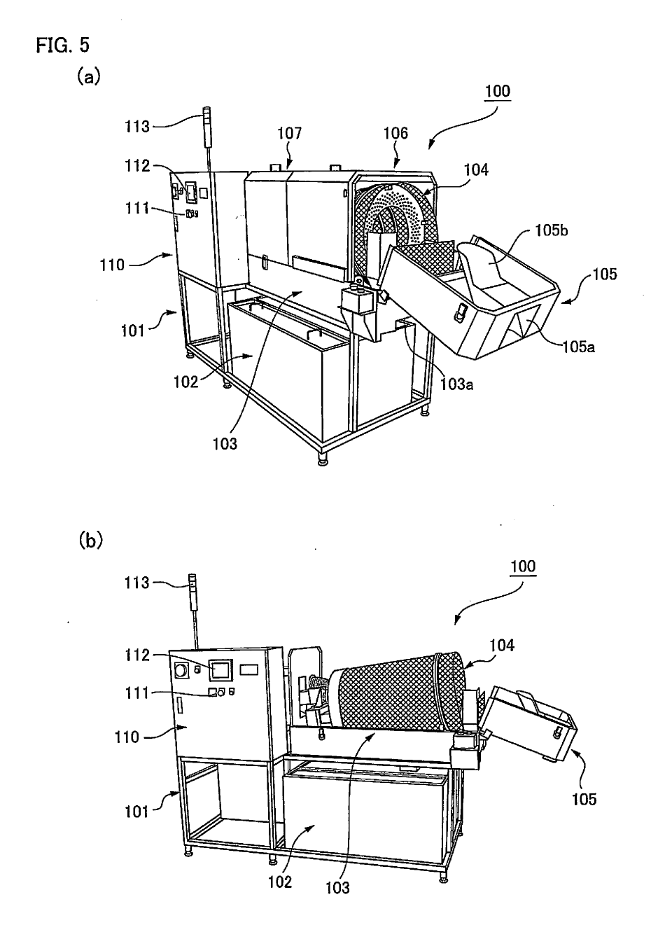

FIG. 4 is an external perspective view showing the rotating drum type workpiece washing apparatus according to Embodiment 2 to which the present invention is applied. FIG. 5(a) is an external perspective view showing a state in which the front cover of the rotating drum type workpiece washing apparatus is open, and FIG. 5(b) is an external perspective view showing a state in which the top cover has been removed. The rotating drum type workpiece washing apparatus 100 is suitable for washing lightweight and soft workpieces such as O rings and seal rings, for example.

The rotating drum type workpiece washing apparatus 100 comprises a rectangular frame-shaped apparatus stand 101, a washing liquid tank 102 is placed in the bottom of the front portion of the apparatus stand 101, and in the top, a rotating drum holder 103 is attached and rotating drum 104 is installed therein. The rotating drum 104 is hidden by a front cover 105 and front and rear top covers 106, 107. The front cover 105 can open forward about the bottom end as shown in FIG. 5(a), and can be removed from the rotating drum holder 103. A workpiece insertion part 105a is formed in the top end surface of the front cover 105, and a chute 105b is attached for leading workpieces inserted into the interior to the rotating drum 104. The top covers 106, 107 can be removed from the rotating drum holder 103 as shown in FIG. 5(b). A workpiece ejection port 103a, out of which workpieces fall after being washed, is opened in the front end of the rotating drum holder 103.

In the rear portion of the apparatus stand 101, a washing liquid circulation pump 108 is installed in the bottom and a hot air generator 109 for drying workpieces is installed in the top. A control board 110 is installed on the left side of the hot air generator 109. The control board 110 controls the driving of the rotating drum type workpiece washing apparatus 100, and disposed in the side surface on the outer side thereof are an operating button 111, a display screen 112, a warning light 113, and other components, as shown in FIGS. 5(a) and (b).

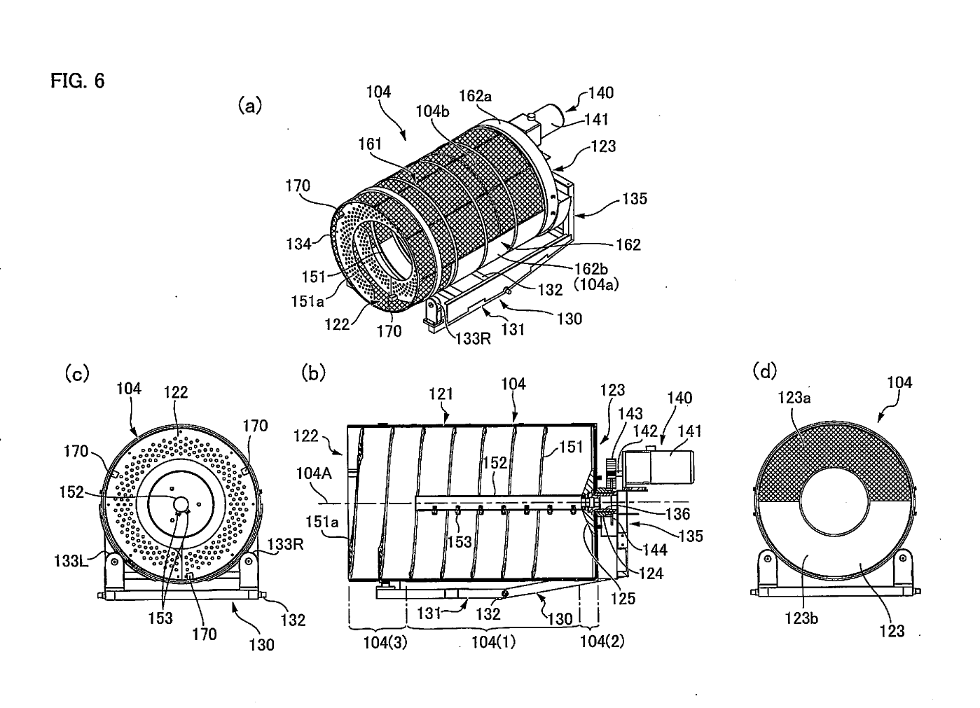

Next, FIG. 6(a) is a perspective view showing an extracted view of the rotating drum 104 and the drive mechanism thereof which are installed in the rotating drum holder 103, FIG. 6(b) is a side view of the same, FIG. 6(c) is a front view showing a workpiece insertion/ejection port of the rotating drum 104, and FIG. 6(d) is a rear view showing the closed end of the rotating drum 104.

Referring to these drawings for a description, the rotating drum 104 comprises a cylindrical body section 121, a workpiece insertion/ejection port 122 formed in the front end thereof, and a closed end 123 where the rear end of the drum is closed. A hollow drum rotating shaft 124 extending coaxially rearward is fixed in the center of the closed end 123, and a discoid rotating section cover 125 is attached to the surface of the inner peripheral side of the closed end 123.

The rotating drum 104 is supported by a drum incline mechanism 130 disposed on the rotating drum holder 103. The drum incline mechanism 130 comprises a rectangular frame-shaped drum holding frame 131, the drum holding frame 131 can be shaken up and down centered around a support shaft 132 extending widthwise in the apparatus in a position halfway along the longitudinal direction, and the orientation of the drum holding frame 131 can be switched by a drive source such as an air cylinder (not shown).

In the distal end (the end near the front of the apparatus) of the drum holding frame 131, a pair of left and right drum supporting rollers 133L, 133R are attached in a rotatable state. An annular rib 134, which is fixed to the external peripheral surface portion of the rotating drum 104 on the side having the workpiece insertion/ejection port 122, is supported by these drum supporting rollers 133L, 133R. A drum support frame 135 which extends upward is attached to the rear end of the drum holding frame 131. A hollow bearing section 136 which faces forward is fixed to the top end of the drum support frame 135. This bearing section 136 is inserted in a rotatable state into the drum rotating shaft 124 from the rear, and the drum rotating shaft 124 is supported in a rotatable state.

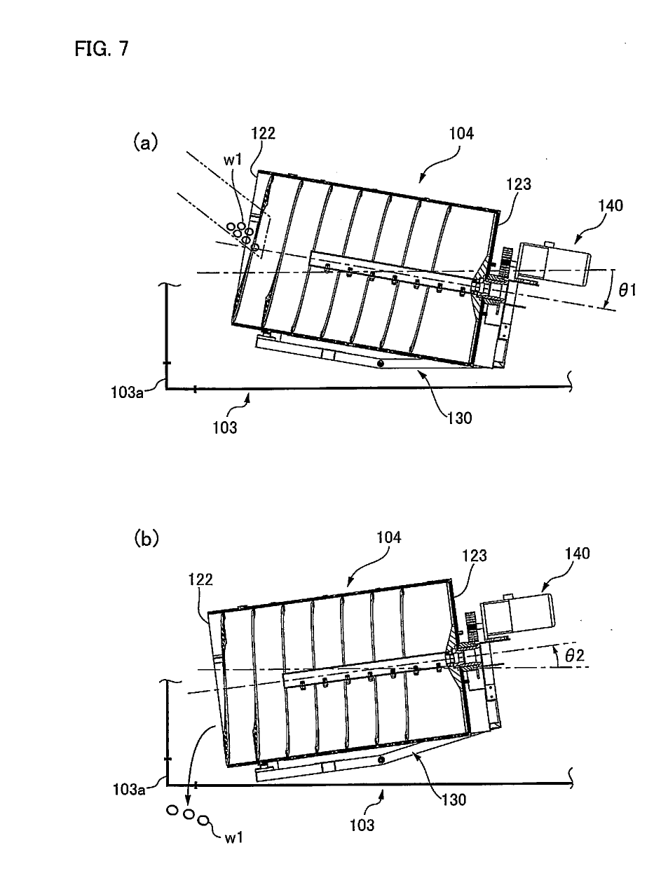

Thus, the rotating drum 104 is supported in the front side in a rotatable state by the pair of left and right drum supporting rollers 133L, 133R, and is supported in the rear end in a rotatable state by the bearing section 136. The rotating drum 104 can be set to a predetermined inclined orientation by shaking the drum holding frame 131 of the drum incline mechanism 130 up and down about the support shaft 132. In the present example, as described hereinafter (see FIG. 7), the drum can be switched between an inclined orientation in which the side having the workpiece insertion/ejection port is at the top, and an inclined orientation in which the side having the workpiece insertion/ejection port is at the bottom

Next, a drum rotation mechanism 140 for rotatably driving the rotating drum 104 about the center axis 104A thereof is installed on the drum incline mechanism 130. The drum rotation mechanism 140 comprises a rotation actuator 141 composed of a motor and a speed reducer, a drive gear 143 fixed to a rotation output shaft 142 of the rotation actuator 141, and an annular driven gear 144 fixed to the external peripheral surface portion of the drum rotating shaft 124. When the rotation actuator 141 is driven, the rotating drum 104 rotates about the center axis 104A.

Next, attached to the circular internal peripheral surface of the rotating drum 104 is a workpiece feeding fin 151 arranged at a constant pitch with a helical shape along the center axis 104A. The workpiece feeding fin 151 is located on the internal peripheral surface of the cylindrical body section 121 of the rotating drum 104, and the fin extends from the open edge on the side having the workpiece insertion/ejection port 122 to the closed end 123 on the rear side.

A washing liquid supply tube 152 extends from the rear end of the rotating drum 109 through the interior of the hollow bearing section 136 and coaxially through the rotating drum 104, the distal end thereof reaching proximal to the workpiece insertion/ejection port 122. Washing liquid spray nozzles 153 are disposed in the washing liquid supply tube 152, at fixed intervals along the length direction thereof. Washing liquid is sprayed out at a downward incline from the washing liquid spray nozzles 153.

The cylindrical body section 121 of the rotating drum 109 comprises a wire netting cylinder 161 composed of a wire netting of a predetermined mesh, and a cover 162 composed of a metal plate hiding part of the external peripheral surface of the wire netting cylinder 161. The cover 162 comprises a narrow cylindrical portion 162a hiding the external peripheral surface portion at the rear end of the wire netting cylinder 161, and an arcuate plate portion 162b hiding the external peripheral surface portion of the wire netting cylinder 161 over only half of the circumferential direction. The wire netting cylinder 161 is exposed in a portion of a fixed width, from the distal end of the arcuate plate portion 162b to the workpiece insertion/ejection port 122.

Therefore, in a portion of a fixed width of the cylindrical body section 121 to which the arcuate plate portion 162b is attached is a first cylindrical body section 104(1), wherein half of this portion in the circumferential direction is a liquid passable portion 104b, and the other half is a liquid impassable portion 104a composed of a metal plate. The portion in the rear side thereof is a second cylindrical body section 104(2) composed of a metal plate through which liquid cannot pass, and the portion in the front side of the first cylindrical body section 104(1) is a third cylindrical body section 104(3) composed of the wire netting cylinder 161 through which liquid can pass.

Furthermore, the closed end 123 in the rear side of the rotating drum 104 is configured from a circular plate-shaped end plate 123a composed of a wire netting, and a closed plate 123b composed of a metal plate hiding a substantially semicircular portion of the endplate 123a, as shown in FIG. 6(d).

Next, FIG. 7(a) is a side view showing the rotating drum 104 in a workpiece-in state of the rotating drum type workpiece washing apparatus 100, and FIG. 7(b) is a side view showing the rotating drum 104 in a workpiece-out state.

As shown in FIG. 7(a), when workpieces w1 are inserted into the rotating drum 104 from the workpiece insertion/ejection port 122 and washing is performed while the workpieces are fed into the rear end side, the drum incline mechanism 130 maintains a state such that the rotating drum 104 is inclined at an angle θ1 so that the center of the workpiece insertion/ejection port 122 is positioned higher than the center of the closed end 123. In this state, the rotating drum 104 is rotated while washing liquid is supplied, and the workpieces w1 are fed in while being washed.

Conversely, after the workpieces w1 have been fed to the rear end of the rotating drum 104, the rotating drum 104 is kept at an incline of an angle θ2 facing backwards, so that the center of the workpiece insertion/ejection port 122 is positioned slightly lower than the center of the closed end 123, as shown in FIG. 7(b). In this state, the washed workpieces w1 are fed out to the workpiece insertion/ejection port 122 by the workpiece feeding fin 151 due to the reverse rotation of the rotating drum 104. Through this feeding action, the workpieces w1 fed out can be dried by feeding hot air for drying via the washing liquid supply tube 152.

In the rotating drum type workpiece washing apparatus 100, the incline angle of the rotating drum 104 can be switched by the drum incline mechanism 130 so that the workpiece insertion/ejection port 122 is in a position higher and a position lower than the closed end 123 at the rear side. Lightweight workpieces w1 shaped as rings and made of rubber, plastic, or the like affix readily to the internal peripheral surface of the rotating drum 104 and roll readily along the internal peripheral surface, and accordingly there are cases in which the workpieces cannot be conveyed efficiently by the workpiece feeding fin 151. In the present example, the workpieces can be conveyed efficiently because the incline angle of the rotating drum 104 is switched to lower the conveying direction. Because the entire internal peripheral surface of the rotating drum 104 is defined by the wire netting cylinder 161, lightweight workpieces made of rubber rings can be prevented from staying affixed to the internal peripheral surface, and the workpieces w1 can be conveyed reliably.

A portion equivalent to at least one loop from the open edge of the workpiece insertion/ejection port 122 in the workpiece feeding fin 151 constitutes a workpiece feeding fin 151a made of punched metal which is taller than the other portions, as shown in FIGS. 6 and 7. In an internal corner facing the workpiece insertion/ejection port 122 defined by the punched metal workpiece feeding fin 151a and the internal peripheral surface of the cylindrical body section 121, protruding pieces 170 are attached at predetermined intervals along the punched metal workpiece feeding fin 151a. Protruding pieces or protruding sections may also be formed in the surface of the punched metal workpiece feeding fin 151a on the side facing the workpiece insertion/ejection port 122. Protruding pieces or protruding sections may also be formed in the internal peripheral surface of the cylindrical body section 121, in the portion between the workpiece feeding fin 151a and the workpiece insertion/ejection port 122.

Thus, when the washed workpieces w1 are ejected from the workpiece insertion/ejection port 122, ring-shaped workpieces w1 can be prevented from rolling along the internal peripheral surface portion in the open edge of the workpiece insertion/ejection port 122 of the rotating drum 104, and the adverse effect of impeding efficient workpiece ejection can be prevented. Specifically, the workpieces w1 rolling along the internal peripheral surface portion collide with the protruding pieces 170 and reliably fall out of the rotating drum from the workpiece insertion/ejection port 122.

In the rotating drum type workpiece washing apparatus 100, formed in the cylindrical body section 121 of the rotating drum 104 are, beginning from the side having the workpiece insertion/ejection port 122: the third cylindrical body section 104(3) composed of a wire netting cylinder, the first cylindrical body section 104(1) wherein part of the external peripheral surface of the wire netting cylinder is hidden by a metal plate, and the second cylindrical body section 104(2) composed of a metal cylinder. When workpieces are fed in, the manner in which the workpieces are washed is initially shower washing in the third cylindrical body section 104(3); then immersion washing, washing by running liquid, and again shower washing in the first cylindrical body section 104(1) as the rotating drum rotates; and immersion washing in the second cylindrical body section 104(2). When workpieces are fed out, the manner of washing workpieces switches to the opposite. Therefore, the effects of washing workpieces can be increased.

1. A rotating drum type workpiece washing apparatus, wherein a transverse-mounted rotating drum is rotated about a center axis thereof, a workpiece inserted into the rotating drum is fed out in a direction of the center axis along an internal peripheral surface portion positioned at a bottom of the rotating drum, the workpiece being fed by a workpiece feeding fin formed in a helical shape along the internal peripheral surface of the rotating drum, and a washing liquid is sprayed onto the workpiece fed out by the workpiece feeding fin to wash the workpiece; the rotating drum type workpiece washing apparatus being characterized in that:
the rotating drum has a cylindrical body section, at least part of the cylindrical body section being a first cylindrical body section for performing immersion washing, washing by running liquid, and shower washing on the workpiece while the rotating drum rotates once; and
in the first cylindrical body section, a portion of a circumferential surface in a predetermined range in a circumferential direction is a liquid impassable portion formed from a plate through which the washing liquid does not pass, and the remaining portion of the circumferential surface in the circumferential direction is a liquid passable portion formed from a porous plate through which the washing liquid does pass.

2. The rotating drum type workpiece washing apparatus according to claim 1, wherein
the rotating drum is rotatably driven in a shaking rotation mode, in which the rotating drum is repeatedly rotated in a first direction, and during each rotation, the rotating drum is repeatedly turned in the first direction and an opposite second direction in a predetermined angle range within one rotation.

3. The rotating drum type workpiece washing apparatus according to claim 2, wherein
the shaking rotation mode is carried out so that the rotating drum is repeatedly turned in the first direction and the second direction within the rotational angle range in which the immersion washing is performed in the rotating drum.

4. The rotating drum type workpiece washing apparatus according to claim 1, wherein
a workpiece raising member is provided for temporarily raising up the workpiece fed by the workpiece feeding fin from the internal peripheral surface of the rotating drum, and wherein
the workpiece raising member is spanned between adjacent feeding fin portions in the workpiece feeding fin, the adjacent feeding fin portions being adjacent in the direction of the center axis.

5. The rotating drum type workpiece washing apparatus according to claim 1, wherein
the workpiece feeding fin has a partitioning feeding fin portion wound one loop or longer along the internal peripheral surface of the first cylindrical body section, and wherein
the partitioning feeding fin portion is taller than other feeding fin portions of the workpiece feeding fin.

6. The rotation drum type workpiece washing apparatus according to claim 1, wherein
the first cylindrical body section of the rotating drum has at least either one of a second cylindrical body section and a third cylindrical body section;
the second cylindrical body section is a portion for performing the immersion washing formed from a plate through which liquid does not pass; and
the third cylindrical body section is a portion for performing the shower washing formed for a porous plate through which liquid does pass.

7. The rotation drum type workpiece washing apparatus according to claim 6, wherein
the third cylindrical body section, the second cylindrical body section, and the first cylindrical body section are formed in the order listed along a workpiece feeding direction of the workpiece feeding fin that accompanies rotation of the rotating drum.

8. The rotation drum type workpiece washing apparatus according to claim 1, comprising:
a drum incline mechanism capable of varying an incline angle of the rotating drum; and
a controller for controlling the rotation of the rotating drum, the incline angle of the rotating drum by the drum incline mechanism, and washing liquid spraying action, wherein
one end of the rotating drum is open as an insertion/ejection port where workpieces are inserted and ejected, and the other end is a closed end, wherein
a workpiece-in washing action and a workpiece-out washing action are alternately performed under control of the controller,
in the workpiece-in washing action, the rotating drum is rotated in a first direction in an inclined orientation wherein the insertion/ejection port of the rotating drum is positioned higher than the closed end and washing liquid is sprayed onto the workpiece while the workpiece is fed in toward the closed end, and
in the workpiece-out washing action, the rotating drum is rotated in a second direction opposite of the first direction in an inclined orientation wherein the insertion/ejection port of the rotating drum is positioned lower than the closed end and washing liquid is sprayed onto the workpiece while the workpiece is fed out from the closed end toward the insertion/ejection port.

9. The rotating drum type workpiece washing apparatus according to claim 8, wherein
the cylindrical body section of the rotating drum has a second cylindrical body section and a third cylindrical body section;
the second cylindrical body section is a portion for performing the immersion washing formed from a plate through which liquid does not pass;
the third cylindrical body section is a portion for performing the shower washing formed from a porous plate through which liquid does pass;
the third cylindrical body section, the first cylindrical body section, and the second cylindrical body section are formed in the listed order beginning at a side having the insertion/ejection port;
a front end of the third cylindrical body section is the insertion/ejection port; and
a rear end of the second cylindrical body section is the closed end.

10. The rotating drum type workpiece washing apparatus according to claim 9, wherein
the cylindrical body section of the rotating drum has a wire netting cylinder and a metal plate attached so as to hide part of an external peripheral surface of the wire netting cylinder, and wherein
the first cylindrical body section is constituted so that a circumferential portion formed by a part of the wire netting cylinder is covered by an arcuate portion of the metal plate,
the second cylindrical body section is constituted so that an entire external peripheral surface formed by a part of the wire netting cylinder is covered by a part of the cylindrical metal plate, and
the third cylindrical body section is formed by a part of the wire netting cylinder.

11. The rotating drum type workpiece washing apparatus according to claim 8, wherein
a portion equivalent to at least one loop from an open edge of the insertion/ejection port in the workpiece feeding fin is a punched metal workpiece feeding fin which is taller than other portions of the workpiece feeding fin, and
protruding members or protruding parts are provided at predetermined intervals along the punched metal workpiece feeding fin in a surface of the punched metal workpiece feeding fin at a side facing the insertion/ejection port, and in a portion of the internal peripheral surface of the cylindrical body section at a side of the insertion/ejection port.
